(19) United States
(12) Patent Application Publication
(10) Pub. No.: US 2022/0374537 A1
(43) Pub. Date: Nov. 24, 2022

(54) METHOD AND DATA PROCESSING SYSTEM FOR SAFEGUARDING DATA AGAINST UNAUTHORIZED ACCESS

(71) Applicants: Robert Lindemann, Wiesbaden (DE); Jonas Hellhund, Frankfurt (DE); Gerome Fischer, Weberstedt (DE); Arne Peters, Bad Homburg (DE)

(72) Inventors: Robert Lindemann, Wiesbaden (DE); Jonas Hellhund, Frankfurt (DE); Gerome Fischer, Weberstedt (DE); Arne Peters, Bad Homburg (DE)

(21) Appl. No.: 17/771,838

(22) PCT Filed: Oct. 27, 2020
(86) PCT No.: PCT/EP2020/080122

§ 371 Date: Apr. 26, 2022

(30) Foreign Application Priority Data
Oct. 28, 2019 (EP) 19205656.2

(51) Int. Cl. G06F 21/62; G06F 21/60

(52) U.S. Cl. CPC G06F 21/6218; G06F 21/602

(57) ABSTRACT

The invention relates to a method and to a data processing system for safeguarding data against unauthorized access and for access thereto. The method for safeguarding comprises: capturing or generating the data to be safeguarded and encrypting same by means of an encryption method which is designed such that the resulting encrypted data cannot be decrypted piece by piece, even if the secret cryptographic key provided for decryption thereof is known, but rather can only be decrypted in its entirety; fragmenting the encrypted data into at least two data fragments each individually representing a true subset and together representing the entirety of the encrypted data; storing the data fragments so as to be distributed over a plurality of non-volatile first data storage devices, wherein at least two of the data fragments are stored in data storage devices, from the plurality of the first data storage devices, which are hosted independently from each other; and storing or initiating storing of event data which, without representing the data or data fragments to be safeguarded or the respective storage locations thereof, document the performed fragmenting, the storing of the data fragments or both, in each case permanently as an occurred event, in at least one distributed ledger.

### FIELD OF THE INVENTION

The present invention relates to a method and a data processing system for securing data, such as in particular medical patient data, against unauthorized access, and to a method for accessing such secured data. Furthermore, the invention relates to a computer program configured to execute the method and to a computer program product comprising such a computer program.

### BACKGROUND

In the context of the ever-increasing importance of data for a wide variety of applications, it is desirable, on the one hand, to acquire, process, store and also link a wide variety of data as effectively and efficiently as possible. In many cases it would be advantageous to host such variety of data on one or more data processing apparatus, especially servers, under common control.

On the other hand, with respect to certain categories of data, there are usually country-specific legal regulations that stipulate, for example, that data relating to the citizens of the relevant country may only be hosted on servers physically present in the country itself. Other personal data, such as medical patient data, is also often requiring strict protections against unauthorized access, including in particular data accumulation, which may preclude the co-hosting of such data. As a result, such data may often be insufficiently available, in particular not easily accessible, for a desired data analysis, which may in particular be an obstacle to technical, scientific or medical progress, even if the subjects to whom the data pertains would consent to this type of analysis. An easy access to the data for the data-owner himself is thus also made more difficult.

Asymmetric cryptography, sometimes referred to as “public key cryptography” or “public/private key cryptography,” is a well-known technology based on a cryptographic system that uses key pairs, where each key pair includes a public key and a private key. The public keys can be widely distributed and are usually even publicly available, while the private keys are kept secret and are usually known only to their owner or holder. Asymmetric cryptography enables both (i) authentication, i.e., when the public key is used to verify that a holder of the paired private key has generated a particular piece of information, e.g., a message or stored data containing the information, by digitally signing it with his private key, and (ii) protection of information, e.g., a message or stored data, by means of encryption, in which case only the owner/holder of the paired private key can decrypt someone else's message that is encrypted with the public key. In addition to asymmetric cryptography, symmetric cryptography also exists, in which the same key is used for encryption and subsequent decryption.

Recently, various so-called “distributed ledger” techniques have been developed, which are techniques for the decentralized creation and management of transaction-related databases or digital ledgers. In contrast to the classic approach, in which a general ledger is usually managed by just one instance, here any number of copies of the so-called “ledger”, which are in principle identical, are maintained decentrally by different parties. Appropriate measures are taken to ensure that new transactions are included in all copies of the ledger, and that there is consensus on the current status of the ledger.

Probably the best-known distributed ledger technology at present is the blockchain. A blockchain is a public ledger in the form of a distributed database that contains a large number of data blocks and maintains an ever-growing list of records and is secured against tampering and revision by cryptographic means. A prominent application of blockchain technology is the Bitcoin virtual currency for internet payments. Another well-known blockchain platform is provided, for example, by the Ethereum project. In essence, a blockchain can be described as a decentralized protocol for logging transactions between partners that transparently records, stores, and keeps all changes to its distributed database “forever,” i.e., as long as the blockchain exists. Storing information in a blockchain involves digitally signing the information to be stored in a block of the blockchain. In addition, maintaining the blockchain involves a process called “blockchain mining,” in which so-called “miners” as part of the blockchain infrastructure verify and seal each block so that the information it contains is stored “forever” and the block can no longer be modified.

Another new distributed ledger technology exemplified here is known as “Tangle,” a block-less and permissionless distributed ledger architecture that is scalable, lightweight, and enables consensus in a decentralized peer-to-peer system. A prominent related technology that uses the Tangle as its technical foundation is known as “IOTA”, a transactional settlement and data integrity layer for the Internet of Things.

### SUMMARY OF THE INVENTION

It is an object of the present invention to provide an improved method and a data processing system for securing data against unauthorized access, by means of which verifiably separately hosted data can be made jointly available in a manner secured against unauthorized access.

This object is achieved by the method and system as described in the independent claims. Various embodiments and developments of the invention are presented in the dependent claims.

A first aspect of the invention relates to a method, in particular a computer-implemented method, for securing data against unauthorized access by means of a data processing system. The method comprises:
(i) capturing or generating the data to be secured, and encrypting the data by means of an encryption method—such as, for example, an asymmetric encryption method like RSA or related methods—which encryption method is arranged such that the resulting encrypted data cannot be decrypted piecemeal, but only in its entirety, even if the secret cryptographic key provided for its decryption is known;
(ii) fragmenting the encrypted data into at least two data fragments, each individually representing a true subset, and all fragments together representing the entirety of the encrypted data; and
(iii) distributing and storing the data fragments across a plurality of respective nonvolatile first data storage devices, wherein at least two of the data fragments are stored in independently hosted data storage devices selected from the plurality of first data storage devices, in particular hosted by different and independent operators.

In the context of the present invention the expression “capturing the data to be stored” may comprise, in particular, capturing an input of the data at a man-machine interface or receiving of the data via a communication interface, or a combination of both.

In the context of the present invention, a “data storage device”, or “storage device” for short, may refer to (i) a single device or (ii) a system comprising a plurality of data storage devices, each for storing data. In particular, a data storage device may include one or more hard disk storage devices, semiconductor storage devices (e.g., RAM or flash storage devices), or multiple different types of data storage devices, and one or more memory controllers. Non-volatile memory (NVM) refers to a data storage device that, unlike volatile information storage devices such as random access memory (RAM), does not lose the data stored in it when its power supply is interrupted.

In the context of the present invention, two or more data storage devices are “independently hosted” if they do not belong to the same computer system or are not controlled by the same system, e.g., a same computer system such as a server or server network. Their operation thus takes place independently of one another, in particular in such a way that the data storage devices can be operated or controlled by different independent operators or their independent computer systems, and in particular access to the different data storage devices is or can be controlled independently of one another.

In the aforementioned method, the data to be secured that is assigned to a user, for example a patient, is encrypted, and only the user has or can have the cryptographic key required for decryption (first security layer). Further, after encryption, the data to be secured is fragmented, and the fragments are stored in a distributed manner on separately hosted data storage devices (second data protection layer). Hosting on only one system, e.g., server, or under the control of only one entity is thus avoided, so that the above-mentioned legal requirements are met.

Preferred embodiments of the method are described below, each of which, unless expressly excluded or technically impossible, may be combined with each other and with the further aspects of the invention described herein as desired.

According to some embodiments, the method further comprises: Storing, or causing to be stored, event data, which, without itself representing the data or data fragments to be secured or their respective storage locations, permanently document the fragmentation that has occurred, the storing of the data fragments, or both, in particular a combination thereof, in each case as an event that has occurred, in at least one distributed ledger, such as one or more blockchains. The fragmentation and the distributed storage in one or more distributed ledgers, e.g., blockchains, is thus documented in a permanently and unforgeable manner but, however, in such a way that data to be secured, or information on the distributed storage locations, is not itself stored in a distributed ledger. In this way, the advantage of permanent documentation is exploited without having to accept the disadvantage of an externally visible recording of the data to be secured or their storage locations.

According to some embodiments, two or more of the independently hosted data storage devices are located in respective different jurisdictions. This may make it difficult, or even impossible, to allow for a single jurisdiction to order to make available all of the data fragments distributed across the different data storage devices.

According to some embodiments, the method further comprises storing references or reference chains (i.e., chained or serially linked references), each defining a link between an identity—such as an associated name or other associated designation—of the data to be secured and the respective locations of the associated data fragments stored in the first data storage devices, in at least one reference management entity (hereinafter also referred to as “librarian”), preferably formed separately from the first storage devices.

These references or reference chains can be regarded, data-wise, in particular as an intermediate layer between the data providers or data receivers of the data to be secured, on the one hand, and the actual distributed storage locations storing the secured data, on the other hand. This can be done, for example, by creating two or three intermediate assignment rules in the form of a reference chain, each of which individually representing a directory that maps a transformation in the context of the reference chain between an input side and an output side of the reference and which, as a whole combined to a reference chain, represent the intermediate layer. However, this intermediate layer is ignorant of the data to be secured itself. One or more of the references may be implemented in particular by means of tables or related, in particular equivalent, data structures and/or data links (e.g., hyperlinks or the like) or pointers.

Accordingly, in some embodiments storing reference chains comprises storing
(i) a first set of references (“first instance”), each defining a link between an identity of the data to be secured, an associated one of the data fragments, and a data storage device for storing the respective data fragment, and
(ii) a second set of references (“second instance”), each defining a link between the data fragments and their respective storage locations in the first data storage devices. The first set of references and the second set of references are each hosted separately by different hosts. Thus, the chains of references each formed by a reference from the first set and a corresponding reference from the second set collectively implement a reference from an identity of the data to be secured to the respective storage locations of the data fragments stored in the first data storage devices associated with the data to be secured. The implementation of the references of the second set, which is separate from the first set, can be used in particular to increase the achievable level of security. This is especially true if the two sets are hosted separately from each other.

One or more, in particular all, of the reference chains may, without being limited thereto, in particular consist of exactly one reference from the first set and a corresponding reference from the second set. Furthermore, the references of the first and second set can thus be dynamically changed independently, which can be used, in particular, to keep up to date the reference provided by the respective reference chain to dynamically changing storage locations for the data fragments, through changes of the references of the second set, which is independent of the first set.

A second aspect of the invention relates to a method for accessing data secured in accordance with the aforementioned method according to the first aspect. The access method, which may in particular be implemented as a process component or module of the method according to the first aspect, or separately thereof, comprises:
(i) generating or receiving an access request for a read access to the secured data;
(ii) determining, by means of the at least one reference management entity, the respective storage locations of the data fragments stored in the first data storage devices and associated with the data to be read;
(iii) providing, on the basis of their determined storage locations, (iii-1) the data fragments themselves, and (iii-2) respective addresses of the storage locations for a read access to the data fragments. In this way, access to the data fragments stored at the various storage locations is made possible, and thus to the secured data they represent as a whole, via the at least one reference management entity providing the intermediate layer. Only this entity knows where and how, at any given time, the various data sets (i.e., the data requested in the context of the access) are split into data fragments, and at which storage location each of these data fragments is stored and can be retrieved via a corresponding addressing.

According to some further embodiments, a read access to the data fragments is provided by means of corresponding temporary addresses for their respective storage locations or is performed by means of these. After a successful read access to the data fragments, the temporary addresses are then changed in such a way that subsequent access to the same data fragments using the same temporary addresses becomes impossible.

The change can in particular affect all temporary addresses of the data storage devices involved or only the temporary addresses involved in the read access. The information about the storage locations of a data fragment made available in the context of the first access in response to the associated first access request (“query”) thus becomes useless after this first access request because, due to the change of the temporary addresses, the routes to the data change with each further access request. Consequently, the same data cannot be accessed twice via the same route.

Preventing accessing the data fragments again using the previously used temporary addresses can be done in particular by modifying the temporary addresses so that they do not point to any valid location from which data could be retrieved. Thus, any further attempted access based on the same temporary addresses, i.e., the same routes, will not yield any data at all. The address information used for the first access thus corresponds to a one-time link that leads to “void” after the first call. Thus, the security of the secured data can be further increased.

According to some embodiments, the method further comprises storing, or causing to be stored, of event data in the at least one distributed ledger, the event data documenting one or more of the following steps, combined or as individual events, associated with the access request:
(i) generating or receiving the access request;
(ii) providing the read access, the data fragments, or the reconstructed data itself;
(iii) an attempted access or an actual access to one or more of the data fragments. In this way, attempted and successful accesses to the secured data are documented in the at least one distributed ledger, e.g., a blockchain, but without revealing the storage location or data content.

In addition, it is conceivable that—especially for detecting potential misuse attempts—repeated access requests based on the same addressing are also documented. Accesses can be documented in particular via a “plain text-readable” designation of data, especially data fragments via fragment names. Therefore, the actual route from the user (per query) to the respective data fragment is irrelevant. Overall, the aforementioned documentation options equally contribute to increasing the achievable security level, since in particular unsuccessful access attempts, which may originate from unauthorized users, for example, are documented so that they can be followed up, for taking further security measures if necessary. In addition, it is possible to find out and prove beyond doubt whether or which access or access attempt has actually been made and which has not. In the latter case, in particular, the integrity or secrecy of personal or other confidential data secured in accordance with the procedure can be proven.

According to some embodiments, the method further comprises:
(i) performing a read access to the data fragments stored in the first data storage devices and reconstructing the secured data by means of assembling and decrypting the totality of the data fragments read in the process;
(ii) encrypting the reconstructed data using a cryptographic key that is different from the one originally used for the secured data;
(iii) fragmenting the data resulting from this new encryption into at least two new data fragments, each individually representing a true subset and together the totality of this newly encrypted data;
(iv) distributing said new data fragments across a plurality of respective non-volatile second data storage devices for respective storage therein, wherein at least two of said data fragments are stored in independently hosted data storage devices selected from said plurality of second data storage devices;
(v) storing, or causing to be stored, in said at least one distributed ledger, event data which, without itself representing said reconstructed data or said data fragments or their respective storage locations, permanently documents, in said at least one distributed ledger and as a respective event that occurred, the read access, the occurrence of fragmentation of the newly encrypted reconstructed data, or the storage of the new data fragments, respectively.

In this way, the successfully read data is thus distributed again in accordance with the method originally used to secure it, but using a different cryptographic key, optionally a different fragmentation, and/or different distribution to second data storage devices, which may either be different from the first data storage devices or may be at least partially identical to them. Consequently, re-accessing the data based on the access information used for the previous access is no longer possible, which equally contributes to increasing the achievable security of the secured data.

Accordingly, in some embodiments, the method further comprises providing the cryptographic key used for the new encryption exclusively to one or more authorized users designated as key holders. In this way, unauthorized access to the secured data can be countered.

In some embodiments, read access is performed in response to an access request from an authorized user (or user device) by a key management entity, which is separated from the authorized user, wherein the key management entity is provided with the cryptographic keys required for decryption and newly encrypting, in response to an authorization of the user in the context of the access request, without these keys actually being made available to the authorized user himself. In this way, security can be further enhanced. In particular, a central key management entity that is well secured against unauthorized access can be used, for storing the keys of various users and selectively making them available for the respective encryption or decryption of the data of a user in accordance with an authorization originating from that user.

In addition, in some embodiments, the method may provide that, in the context of the new storage of the data fragments in the second storage devices, storage locations in the first data storage devices that are no longer needed are released for other use, in particular for storage of other data to be secured.

The embodiments described below may be equally applicable to the methods according to the first and/or the second aspect:

According to some embodiments, the method further comprises storing duplicates of the data fragments in third data storage devices hosted independently of each other and of the first storage devices, each non-volatile, such that at least two of the duplicates of different data fragments are stored in a distributed manner across two non-co-hosted third data storage devices. In this way, redundancy can be achieved for further increasing the secure availability of the secured data, particularly with respect to potential technical defects in the first storage devices or the access paths thereto.

In some of these embodiments, two or more of the independently hosted third data storage devices are located in respective different jurisdictions. This may make it difficult, or even impossible, to allow for a single jurisdiction to order to make available all duplicates of the data fragments distributed across the different third data storage devices.

According to some embodiments, throughout the entire process executed in the data processing system, the data to be secured or already secured is temporarily stored, to the extent that it is temporarily stored in whole or in part in unencrypted form at all, outside of the fragmented and distributed storage in the data storage devices, is exclusively stored in one or more volatile data storage devices. The same may optionally apply to the cryptographic keys used for the encryption or decryption of the secured data. Thus, while maintaining the procedural data processing tasks, storage of the data in its entirety in non-volatile memory, which could be considered hosting, is avoided, so that the corresponding legal requirements for “non-hosting” of certain data, in particular personal data, can be satisfied. Moreover, with respect to the keys, their secure handling can be further improved, which applies in particular to keys whose secrecy is security-relevant, such as a private key of an asymmetric encryption method or the one key of a symmetric encryption method.

According to some embodiments, the method further comprises an active deletion of any representations of the data to be secured or of the cryptographic key used for its encryption or decryption that happen to be temporarily stored in unencrypted form in one or more volatile memories throughout the process. In this way, any unauthorized reading of the data from the storage devices, which might otherwise still be possible, can be prevented. Active erasure, for example by means of one or more overwrites with random values, can be advantageous in particular if
(i) during (non-active) normal erasure the data itself is typically not erased, but the storage locations concerned are only marked as “free” in the memory management, or
(ii) despite a change in the contents of the storage locations during normal erasure, residues nevertheless remain in the memory which, at least by forensic means or other special analysis means, still allow conclusions to be drawn about the previously stored data contents. Thus, by means of active erasure, the achievable security can be further increased.

A third aspect of the invention relates to a data processing system configured to execute the method according to the aforementioned first and/or second aspect of the invention, in particular according to one or more of the corresponding exemplary embodiments described herein. In particular, the data processing system may comprise one or more user-side data collection devices, as well as one or more central computer-implemented entities, such as in particular the reference management entity and the aforementioned first as well as possibly also second and/or third data storage devices.

Accordingly, in some embodiments the data processing system comprises one or more data collection devices, each of which being a medical device or a patient data collection device, for at least partially collecting or generating the data to be secured. In this way, patient-related data can be transferred to the data processing system without intermediate storage, directly at the point of origin, where it can be reliably secured against unauthorized access, as described above, in compliance with the statutory regulations on “non-hosting”.

According to some of these embodiments, at least one of the data collection devices is configured as a medical device and has at least one of the following functionalities: (i) fluid management; (ii) purification of body fluids; (iii) blood purification, in particular dialysis. Particularly in the case of this type of device, significant amounts of patient-related data, which may be subject to special legal protection, regularly accumulates due to its usually repeated use in accordance with a prescription, so that a direct connection to or integration of the data collection devices into the data processing system is particularly advantageous in order to ensure the required data security.

In this context, medical fluid management devices are understood to mean, in particular, devices for conducting, treating and/or distributing of fluids and/or gases, in which devices fluid is transported between a patient and a fluid treatment component and/or a fluid source via a fluid line.

In particular, fluid management devices are also meant to include fluid treatment devices, such as blood treatment devices, in which a fluid from a patient is supplied to a fluid treatment component via a fluid line, is treated by the fluid treatment component, and is returned to the patient via the fluid line, which may be divided into an arterial branch and a venous branch. Examples of such blood treatment devices include, in particular, hemodialysis devices. Such a blood treatment device is the subject matter of DE 198 49 787 C1 of the applicant, the contents of which are hereby fully incorporated in the disclosure content of the present application.

Dialysis is a procedure for blood purification in patients with acute or chronic renal insufficiency. In principle, a distinction is made here between procedures with an extracorporeal blood circuit, such as hemodialysis, hemofiltration or hemodiafiltration, and peritoneal dialysis, which does not have an extracorporeal blood circuit.

In hemodialysis, blood is circulated in an extracorporeal circuit through the blood chamber of a dialyzer, which is separated from a dialysate fluid chamber by a semipermeable membrane. A dialysis fluid containing the blood electrolytes in a certain concentration flows through the dialysis fluid chamber. The substance concentration of the blood electrolytes in the dialysis fluid corresponds to the concentration in the blood of a healthy person. During treatment, the patient's blood and the dialysis fluid are each passed along one side of the semipermeable membrane, generally in countercurrent at a predetermined flow rate. The urinary substances diffuse through the membrane from the blood chamber to the dialysis fluid chamber, while electrolytes present in the blood and dialysis fluid simultaneously diffuse from the higher concentration chamber to the lower concentration chamber. If a pressure gradient is established at the dialysis membrane from the blood side to the dialysate side, for example by a pump withdrawing dialysate from the dialysate circuit downstream of the dialysis filter on the dialysate side, water from the patient's blood passes over the dialysis membrane into the dialysate circuit. This process of ultrafiltration leads to a desired dehydration of the patient's blood.

In hemofiltration, ultrafiltrate is removed from the patient's blood by applying a transmembrane pressure in the dialyzer without passing dialysis fluid on the side of the dialyzer membrane opposite the patient's blood. In addition, a sterile and pyrogen-free substitute solution can be added to the patient's blood. Depending on whether this substitute solution is added upstream of the dialyzer or downstream, it is referred to as pre-dilution or post-dilution. In hemofiltration, the exchange of substances takes place convectively.

Hemodiafiltration combines the processes of hemodialysis and hemofiltration. There is both a diffusive exchange of substances between the patient's blood and the dialysis fluid via the semipermeable membrane of a dialyzer and a filtration of plasma water through a pressure gradient at the membrane of the dialyzer.

The procedures of hemodialysis, hemofiltration and hemodiafiltration, hereinafter summarized under the term hemodialysis, are usually performed with automatic hemodialysis machines, such as those marketed by the applicant under the designation 5008.

Plasmapheresis is a blood treatment procedure in which the patient's blood is separated into the blood plasma and its corpuscular components (cells). The separated blood plasma is purified or replaced with a substitution solution, and the purified blood plasma or substitution solution is returned to the patient.

In peritoneal dialysis, a patient's abdominal cavity is filled with a dialysis fluid that has a concentration gradient compared to the body's own fluids via a catheter passed through the abdominal wall. The toxins present in the body pass into the abdominal cavity via the peritoneum, which acts as a membrane. After a few hours, the now depleted dialysis fluid in the patient's abdominal cavity is replaced. Osmotic processes allow water from the patient's blood to pass through the peritoneum into the dialysis fluid, thus dehydrating the patient.

The peritoneal dialysis procedure is generally performed using automatic peritoneal dialysis machines, such as those marketed by the applicant under the name sleep.safe.

A fourth aspect of the invention relates to a computer program comprising instructions which, when executed on a data processing system according to the third aspect of the invention, cause the data processing system to execute the method according to the first and/or second aspect of the invention.

In particular, the computer program may be stored on a non-volatile data carrier. Preferably, this is a data carrier in the form of an optical data carrier or a flash memory module. This may be advantageous if the computer program as such is to be traded independently of a processor platform on which the one or more programs are to be executed. In another implementation, the computer program may be present as a file on a data processing unit, particularly a server, and downloadable via a data connection, such as the Internet or a dedicated data connection, such as a proprietary or local area network. In addition, the computer program may have a plurality of interacting individual program modules.

Accordingly, the data processing system according to the second aspect of the invention may comprise one or more program memories in which the computer program is stored, optionally distributed over a plurality of program memories. Alternatively, the data processing system may be arranged to access a computer program available externally, for example on one or more servers or other data processing units, via a communication link, in particular in order to send and receive data, which data is used during the execution of the method or computer program, or represent an output of the computer program.

The features and advantages explained with respect to the first or second aspect of the invention apply accordingly to the further aspects of the invention.

Further advantages, features and exemplary applications of the present invention will be apparent from the following detailed description in connection with the drawing. In the drawing

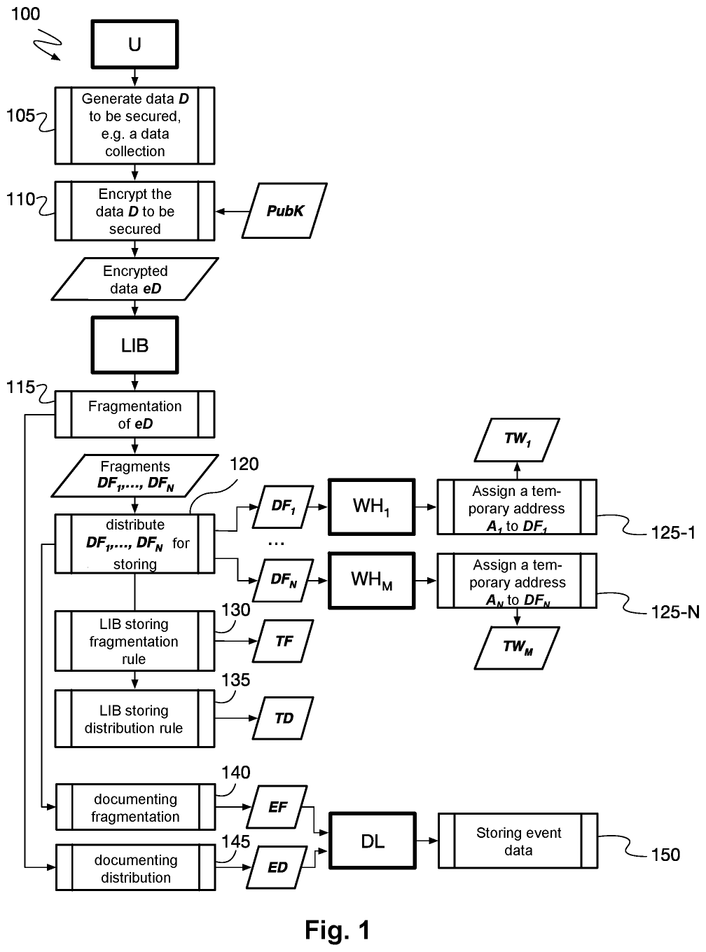

FIG. 1 shows a flowchart illustrating a first exemplary embodiment of the method according to the first aspect of the invention for securing user-generated data;

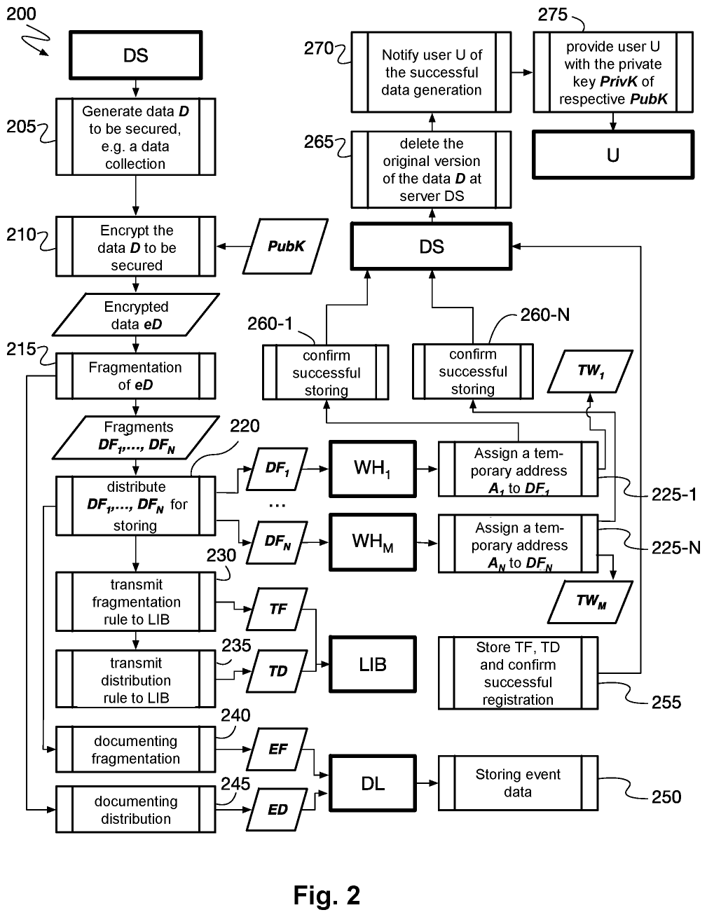

FIG. 2 shows a flowchart illustrating an alternative second exemplary embodiment of the method according to the invention according to the first aspect of the invention for securing data that is not directly generated by the user;

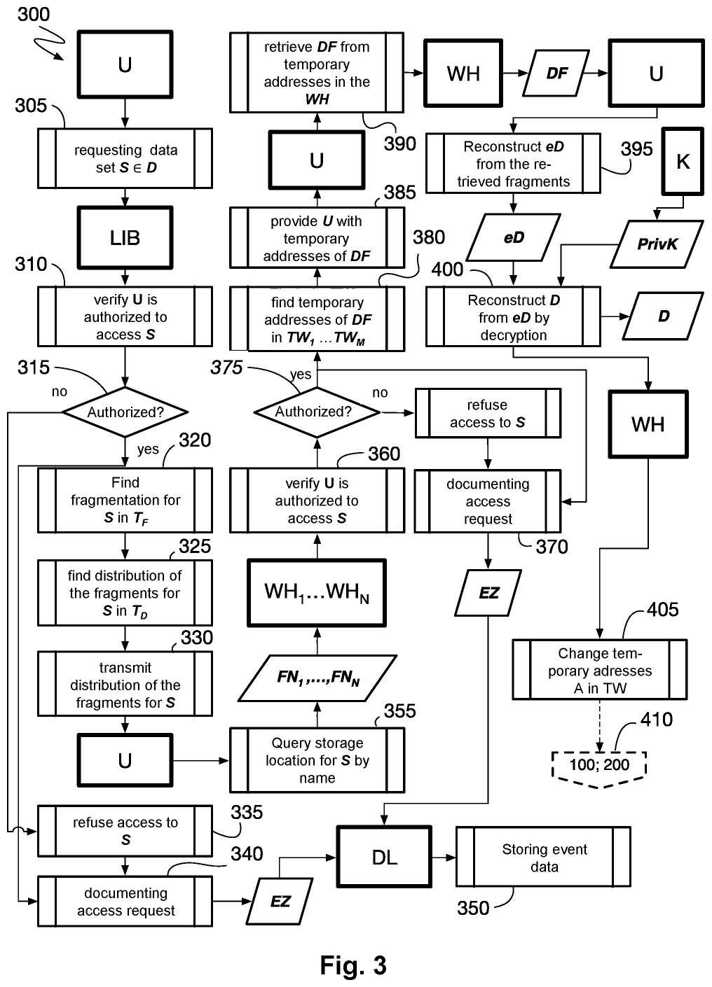

FIG. 3 shows a flowchart illustrating a method of accessing data already secured in accordance with the invention, according to an exemplary embodiment of the access method according to the second aspect of the invention; and

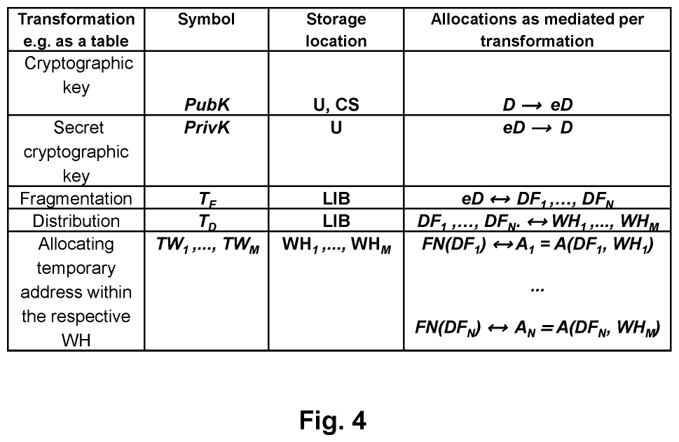

FIG. 4 shows a summary table illustrating the various transformations used in the context of the methods of FIGS. 1 to 3.

In addition, the above flowcharts show not only the respective process flow, but also (in boxes with thick lines) the various elements of an exemplary data processing system according to the invention configured to carry out the respective process.

In the figures, the same reference designators are used for the same or corresponding elements of the invention.

The flowchart illustrated in FIG. 1 includes, in particular, the following components of a data processing system according to the invention, which interact with each other as shown to jointly perform the method 100 illustrated in FIG. 1: (i) data collection device U of a user, for example a patient, or which is used for treatment, for example dialysis, of a particular patient, (ii) reference management entity (“librarian”) LIB, distributed ledger DL, e.g., blockchain, (iii) data storage devices (“data warehouse”) WH₁, . . . , WH_{M}.

To the extent that the flowchart depicts, along its course between a particular first one of the system components and a second one of the system components, which is located further downstream and follows immediately, one or more process steps or processes, this means that this or these are performed by the first one, i.e., the one located next upstream of the process in each case, of the system components. For example, 105 in FIG. 1 is performed by system component U, while step 115 is performed by system component LIB.

In particular, the process 100 may be implemented by means of one or more computer programs running on one or more components of the system. To this end, the data processing system, in particular its relevant components, may comprise one or more integrated or external (not shown) program memories or other computer program products, in particular non-volatile data carriers, for storing the computer program(s).

In the method 100 illustrated in FIG. 1, data D to be secured is generated by the user, or more specifically his data collection device U, in step 105. In particular, this may involve providing medical information, collected by means of a medical measurement performed by means of the data collection device U for diagnostic purposes or a therapy performed on the patient by means of the device, together with associated patient data, such as name, age, gender, etc., in the form of one or more corresponding data sets as data D to be secured. Thus, the data collection device U may be, in particular, a medical device or a device for collecting patient-related data, or a combination of both. In particular, this device U may have a fluid management functionality and may be set up for this purpose, for example, for the purification of body fluids, in particular for blood purification (e.g., by dialysis).

The data collection device U can also be designed, in particular, such that it can be signal-coupled to a computer, in particular a mobile computer, for the purpose of data collection, so that inputs or data queries from or to the computer are possible and the data generation or retrieval functionality can be performed in interaction between the data collection device U and the computer coupled thereto. For example, a medical fluid management device serving as a data collection device may be equipped with: a control device, an interface configured to exchange data with a mobile computer, and a mechanical coupling device configured to couple to a correspondingly configured counterpart on the mobile computer, wherein the control device is configured to send information concerning the medical fluid management device and/or a treatment performed with the medical fluid management device to the mobile computer via the interface and/or to receive operating inputs entered at the mobile computer or control signals from the mobile computer.

Now referring again to the method 100 itself, further, in step 110 the data D to be secured is encrypted. In principle, this can be done by means of any sufficiently secure encryption method, wherein symmetrical or asymmetrical encryption methods may be used. In the present example of the method 100, an asymmetric encryption method has been selected, so that the data D to be secured is encrypted by means of a public key PubK of a public/private key pair, in order to obtain encrypted data eD and transmit it to the reference management entity LIB. In this case, the key pair is preferably assigned to the user or the patient using the device U. Accordingly, only this authorized user or patient should be able to dispose of the associated private key PrivK of the key pair, either directly or indirectly via an intermediate key management entity K.

The reference management entity LIB, which is ideally executed separately from the data collection device U, for example on a central server of the data management system with which a plurality of data collection devices U may be in communication, performs, in step 115, a fragmentation of the encrypted data eD to obtain a plurality N of data fragments, or “fragments” for short, DF₁, . . . , DF_{N}. In principle, any fragmentation rule can be used for this purpose, such as a serial splitting of the encrypted data eD into successive data sections whose individual fragments are of equal sizes or of different sizes, as long as an information is provided as to how the encrypted data eD can be reconstructed from the individual fragments.

Further, in step 120 the reference management entity LIB distributes the N previously generated fragments DF₁, . . . , DF_{N} in accordance with an N:M allocation, in particular one that can be randomly selected or follows a secret allocation scheme, to M different data storage devices (data warehouses) WH₁, . . . , WH_{M} for storing, so that each of the data storage devices WH₁, . . . , WH_{M} receives at most one true subset of the set {DF₁, . . . , DF_{N}} of the fragments and thus results in a true distribution of the fragments over at least two data storage devices. Optionally, for redundancy reasons, copies of data fragments can additionally be stored in further non-volatile data storage devices (not shown).

The data storage devices themselves can each have one or more physical data storage devices, for example hard disks, semiconductor memory chips or modules, magnetic tapes, etc., which are logically combined, in particular by means of appropriate addressing, to form a data storage device.

For addressing a data fragment, each of the fragments is assigned a corresponding temporary address A∈{A₁, . . . , A_{N}}, by which it is addressable within the data storage devices in which the respective fragment is stored, in a respective corresponding further step 125-1, . . . , 125-N. The assignment of the temporary addresses to the respective fragments is stored, for each data storage device, as an associated assignment rule TW₁, . . . , TW_{M}, which can be achieved in particular in the form of a respective table or other data structure equivalent thereto. Consequently, in order to be able to access the fragment, a route must be known for accessing, which route contains both an address of the data storage device concerned and the associated temporary address A of the fragment searched for within this data storage device.

Furthermore, in step 130, the reference management entity LIB stores the fragmentation rule TF used for fragmentation and, in step 135, the distribution rule TD used for distributing the fragments to the data storage device, each in a memory associated with the reference management entity LIB. This can likewise be done, for example, by means of a data table or an equivalent data structure.

For the purpose of an unforgeable and permanently traceable documentation, in step 140 event data EF, which represent the fragmentation that has taken place, are transmitted to at least one distributed ledger DL, such as a predetermined blockchain. Similarly, in step 145, the distribution that has taken place is also documented, in the same way, by transmitting corresponding event data ED representing it to the distributed ledger DL, where EF and ED are stored in one or more steps 150. This can be done in a known manner, in the case of a blockchain in particular by means of blockchain mining, for which one or more further entities, so-called “miners” may be used. However, the secured data itself is not stored in the distributed ledger in any way, in particular neither in unencrypted nor in encrypted or fragmented form.

As a result, in the context of method 100, data D to be secured is thus generated and secured with the aid of several security layers, which include in particular encryption, fragmentation, distribution of the fragments to various data storage devices, temporary addressing in the data storage devices, and unforgeable documentation of at least part of the aforementioned operations. In this process, the data is preserved for later authorized access, but without the data being hosted by a single host. Thus, for later successful access, a number of different pieces of information are required which, together, form a chain of references, and which include, in particular, the information stored in TW₁, . . . , TW_{M}, TF, and TD, respectively, for the accessing the requested data, as well as the private key PrivK required for decrypting the data eD reconstructed after accessing (see FIG. 4).

FIG. 2 shows an embodiment 200 of a method according to the invention for storing data to be secured, which is an alternative to the method 100. In contrast to the method 100, here the data D to be secured is not generated by the user or his data collection device U itself, but by another entity DS, which may in particular be a server specifically provided for this purpose and is therefore referred to hereinafter as (data source server).

Accordingly, in the context of the method 200, data D to be secured is generated by the data source server DS in step 205 and, using the public key PubK of an authorized data owner, for example a particular patient, are encrypted in a following step 210, for obtaining encrypted data eD. Next, in step 215, the data source server DS likewise performs fragmentation of the encrypted data eD, for obtaining N data fragments DF₁, . . . , DF_{N} and, in a further subsequent step 220, distributes them to a plurality M of data storage devices WH₁ to WH_{M} for respective storing. This fragmentation and distribution, which takes place in steps 215 and 220, and the subsequent assignment of respective temporary addresses A∈{A₁, . . . , A_{N}} to the individual fragments in the respective data storage devices WH₁ to WH_{M}, which takes place in steps 225-1 to 225-N, correspond in their nature to the respective steps 115, 120 and 125-1 to 125-N in FIG. 1.

In addition, however, in the method 200 in steps 260-1 to 260-N subsequent to steps 125-1 to 125-N, a confirmation of successfully completed storing of the data fragments DF₁, . . . , DF_{N} is transmitted to the data source server DS, from those data storage devices WH₁, . . . , WH_{M} storing a true subset from the set {DF₁, . . . , DF_{N}} of the data fragments, for correspondingly informing the data source server DS.

Furthermore, in step 230 the fragmentation instruction TF, as well as in step 235 the distribution instruction TD are transmitted to the reference management entity LIB which, in step 255, stores this information with itself (registration) and likewise reports this storing to the data source server DS after its successful execution.

When the data source server DS has received the confirmation messages from steps 255 and 260-1 to 260-M, it interprets this as confirmation of successful storage of the encrypted, fragmented and distributed data D to be secured, so that in step 265 it deletes the original version of the data D that was previously held by itself and is now no longer required. This deleting may in particular comprise an active deleting in which the actual contents of the relevant memory locations, for example memory cells in a semiconductor memory, are physically erased, which may in particular be performed by means of multiple overwriting with random data. Other means known to the skilled person for actively deleting data memory contents may also be used instead or in addition.

Finally, the user to whom the data is assigned or belongs is notified of the successful data generation and storing in step 270, and is also provided with the private key PrivK in a manner secured against unauthorized access in step 275. Alternatively, the private key may instead be provided to an optional additional key management entity K provided in the data processing system, so that the user can indirectly dispose of his private key PrivK via the key management entity K, but without actually having to know and directly possess the key.

Both methods 100 and 200 are preferably implemented in such a way that none of the system components of the data processing system involved therein stores or has available the entirety of the data D to be secured in a non-volatile data memory at any time. The same applies to the data access procedure 300, which will be described further below. Thus, at no time non-volatile storage or hosting of the entirety of the data is performed in a single entity and, thus, at no time under unified control.

Finally, in the method 200, in steps 240 to 250, event data is stored in the distributed ledger DL in a manner corresponding to steps 140-150 of method 100, which event data serves for documenting, in an unforgeable manner, the generation (fragmentation) and distribution of the data fragments that has occurred.

FIG. 3 illustrates an exemplary embodiment of a method or method section 300 for accessing data D already secured in accordance with the method 100 or 200. In the present case, a user wishes to access a data set S, reconstructed from previously secured data D stored in the data processing system, via his device U, which may be the device used for data collection in the method 100, or another suitable device. For example, the data set S may relate to a particular medical measurement or therapy for the user or patient, such as a dialysis session.

First, in step 305 the user transmits the request for the data set S to the reference management entity LIB. There, in step 310, a verification is performed for determining whether U is authorized to access the data set S. This authorization can take place in various ways, wherein in particular conventional known and authentication methods can be used, for example the input of a secret code PIN or other secret information suitable for identification, or capturing of one or more biometric characteristics. If it is determined in the course of the verification that the request is not authorized (315—no), access to the data set S is refused in step 335 and, in step 340, the access request, preferably additionally with the information that it was unsuccessful, is reported as access event EZ to the distributed ledger DL and stored therein in step 350. Optionally (not shown), the occurrence of the access request for the data set S can also be reported to the distributed ledger DL beforehand at or after step 305 and stored therein.

Otherwise (315—yes), i.e., if the authorization is successful, the reference management entity LIB performs a search in the mapping rule TF for the fragmentation belonging to the data set S in step 320. Furthermore, in step 325, a search is similarly performed in the mapping rule TD for the associated distribution for the fragments belonging to S. The information obtained in steps 320 and 325, which together form part of a reference chain and also include respective fragment names FN₁, . . . , FN_{N} (collectively referred to hereinafter as FN) or alternatively a respective other unique designation or identifier for each of the data fragments DF₁, . . . , DF_{N} (collectively referred to hereinafter as DF), is transmitted to the user or the user's device U in step 330.

Next, by means of the device U, in step 355 in accordance with the corresponding distribution for the fragments belonging to S, the respective fragment names FN are transmitted to the respective storage locations WH₁, . . . , WH_{M} (collectively referred to hereinafter as WH) storing the fragments. In particular, this can be done globally in such a way that all fragment names are transmitted to all of the participating storage locations, or selectively so that each storage location receives only the fragment name(s) corresponding to the one or more fragments stored therein.

In the respective storage locations WH, the respective information transmitted in step 355 is received and, upon receiving, firstly a further authorization check is performed locally in step 360, for determining whether the user or his device U is authorized to access the data set S. If the authorization check fails (375—no), access to the data set S or its associated fragments is refused in step 365 and the failed access request is transmitted, in step 370, as access event EZ to the distributed ledger LD for storage in step 350. Otherwise (375—yes), the successfully authorized access request is likewise transmitted, in step 370, as a corresponding access event EZ to the Distributed Ledger LD for storage in step 350. Optionally (not shown), as described further above, the occurrence of the access request for the data set S may also be reported to the distributed ledger DL already at or after step 305 and stored there.

In step 380, following successful authorization, the temporary addresses A₁, . . . , A_{N} (collectively referred to hereinafter as A) of the data fragments DF associated with the fragment names FN are identified by means of the respective assignment rules TW₁, . . . , TW_{M} and these are transmitted to the user or his device U in step 385.

On the basis of this information, the user can now, in step 390, request the various data fragments DF with the aid of their now known temporary addresses A from the various storage locations WH, which transmit them to U. The user can then, in step 395. In the subsequent step 395, the secured encrypted data eD can then firstly be reconstructed from the retrieved data fragments DF and, in the further step 400, decrypted using the private key PrivK either known to the user or provided on his behalf by a key management entity K, in order to finally obtain the desired original data D.

Following the successful read access, at the earliest immediately after step 390, a change of temporary addressing can be made, in step 405, in the individual data storage devices WH, so that the previously valid temporary addresses A can no longer be successfully used in a further access attempt to the fragmented secured data D or, more precisely eD. Ideally, the address change takes place in such a way that the previous addresses no longer refer to any valid destinations and thus lead to “void”.

In addition, or alternatively, it may be envisaged, in step 410, to newly encrypt the reconstructed data D using a new key PubK′ (which forms a key pair with a corresponding new private key PrivK′), different from the previous key PubK, and to store it anew using one of the methods 100 or 200. Either the previously involved data storage devices or, alternatively, different data storage devices may be used to store the new data fragments generated in this process, or a combination of both.

FIG. 4 presents a tabular overview of the information PubK and PrivK for encryption and decryption, respectively, TF for fragmentation, TD for fragment distribution and TW₁, . . . , TW_{M} used in the context of the methods 100, 200 and 300 of FIGS. 1 to 3, for temporary addressing, as well as their preferred storage location and the respective transformations or allocations mediated by them.

While at least one exemplary embodiment has been described above, it should be noted that a large number of variations thereon exist. It should also be noted that the exemplary embodiments described are only non-limiting examples, and it is not intended thereby to limit the scope, applicability, or configuration of the devices and methods described herein. Rather, the foregoing description will provide guidance to those skilled in the art for implementing at least one exemplary embodiment, it being understood that various changes in the operation and arrangement of the elements described in an exemplary embodiment may be made without departing from the subject matter set forth in each of the appended claims as well as its legal equivalents.

### LIST OF REFERENCE NUMERALS

A, A₁, . . . , A_{N} temporary address
DS data source server
D data to be secured or secured data, especially data sets
DF, DF₁, . . . , DF_{N} data fragments
DL distributed ledger, e.g., blockchain
eD encrypted data
ED documentation distribution event
EF documentation fragmentation event
EZ documentation access event
FN, FN₁, . . . , FN_{N} fragment names.
K key management entity
LIB reference management entity (librarian)
PrivK private (cryptographic) key
PubK public (cryptographic) key
S retrieved record
TD distribution rule, e.g., distribution table
TF fragmentation rule, e.g., fragmentation table
TW, TW₁, . . . , TW_{N} temporary address allocation rule in the respective WH
U user or its data collection device
WH, WH₁, . . . , WH_{M} data storage devices

1. A method of securing data against unauthorized access by means of a data processing system, the method comprising:
capturing or generating the data to be secured, and encrypting said data by means of an encryption method which ensures that the resulting encrypted data cannot be decrypted piecemeal, even if the secret cryptographic key required for decrypting said encrypted data is known, but only in its entirety;
fragmenting the encrypted data into at least two data fragments, each individually representing a true subset and, taken together, representing the entirety of the encrypted data;
storing the data fragments, distributed across a plurality of respective non-volatile first data storage devices, wherein at least two of the data fragments are stored in independently hosted data storage devices selected from the plurality of first data storage devices,
storing, in at least one reference management entity, of reference chains each defining a link between an identity of the data to be secured and the respective storage locations of the associated data fragments stored in the first data storage devices, wherein storing of reference chains comprises storing a first set of references, each defining a link between an identity of the data to be secured, an associated data fragment, and a data storage device storing the respective data fragment, and storing a second set of references, each defining a link between the data fragments and their respective storage locations in the first data storage devices, and wherein the first set of references and the second set of references are each hosted, separated from each other, by different hosts.

2. The method of claim 1, further comprising:
Storing, or causing to be stored, in at least one distributed ledger, event data which, without itself representing the data or data fragments to be secured, permanently documents the fragmentation that has occurred, the storing of the data fragments, or both, respectively, in each case as an event that has occurred.

3. (canceled)

4. (canceled)

5. A method of accessing data secured in accordance with the method of claim 1, the method comprising:
generating or receiving a request for a read access to the secured data;
determining the respective storage locations of the data fragments associated with the data to be read, which data fragments are stored in the first data storage devices, by means of the at least one reference management entity;
providing, based on the determined respective storage locations of the data fragments, respective addresses of storage locations for read access to the data fragments.

6. The method of claim 5, wherein a read access to the data fragments is provided or effected by means of corresponding temporary addresses for their respective storage locations; and
after a read access to the data fragments has taken place, the temporary addresses are modified in such a way that subsequent access to the same data fragments using the previously used temporary addresses is made impossible.

7. The method of claim 5, further comprising:
Storing, or causing to be stored, event data in the at least one distributed ledger, which event data documents, each individually as one event or as a whole, one or more of the following steps associated with the access request:
generating or receiving the access request;
providing the read access, data fragments, or reconstructed data itself;
an access attempt or a completed access to one or more of the data fragments.

8. The method of claim 5, further comprising:
performing a read access to the data fragments stored in the first data storage devices, and reconstructing the secured data by means of assembling the read data fragments and decrypting them in their totality;
encrypting the reconstructed data using a cryptographic key that is different from the one originally used to encrypt the secured data;
fragmenting the data resulting from this new encryption into at least two new data fragments, each individually representing a true subset and together representing the entirety of this newly encrypted data;
distributing said new data fragments across a plurality of respective non-volatile second data storage devices for respective storage therein, wherein at least two of said data fragments are stored in independently hosted data storage devices selected from said plurality of second data storage devices.

9. The method of claim 2, further comprising:
storing or causing to be stored, in the at least one distributed ledger, event data which, without itself representing the reconstructed secured data, the corresponding data fragments, or their respective storage locations, permanently documents the read access, the fragmentation of the newly encrypted reconstructed data that has occurred, or storing of the new data fragments, in each case as an event that has occurred.

10. The method of claim 8, further comprising:
providing the cryptographic key used for the new encryption exclusively to one or more authorized users identified as key holders.

11. The method according to claim 5, wherein the read access is performed, in response to an access request from an authorized user by a key management entity, which is separated from the authorized user, wherein the key management entity is provided with the cryptographic keys required for decryption or newly encrypting in response to an authorization of the user in the context of the access request, without these keys actually being made available to the authorized user himself.

12. The method according to claim 1, further comprising:
storing duplicates of the data fragments in third data storage devices, hosted independently of each other and of the first storage devices, each non-volatile, such that at least two of the duplicates of different data fragments are stored in a distributed manner across two non-co-hosted third data storage devices.

13. The method of claim 1, wherein, throughout the entire process, the data to be secured or already secured, insofar as parts of it or its entirety is temporarily stored in the data processing system in an unencrypted form, outside the fragmented and distributed storage in the data storage devices, such temporary storage occurs exclusively in one or more volatile data storage devices.

14. The method of claim 1, further comprising:
actively erasing any representations of the data to be secured, or the cryptographic key used to encrypt or decrypt them, that happen to be temporarily stored in unencrypted form in one or more volatile memories throughout the process.

15. A data processing system configured to execute the method according to claim 1.

16. The data processing system of claim 15, wherein the data processing system comprises one or more data collection devices, each of which being a medical device or a patient data collection device, for at least partially collecting or generating the data to be secured.

17. The data processing system of claim 16, wherein at least one of the data collection devices implements a medical device and has at least one of the following functionalities:
fluid management;
body fluid purification;
blood purification;
dialysis.

18. A computer program comprising instructions which, when executed on a data processing system according to claim 15, cause the data processing system to execute the method according to claim 1.
